(19) United States
(12) Patent Application Publication
(10) Pub. No.: US 2006/0098280 A1
(43) Pub. Date: May 11, 2006

(54) Screen, image projection system having the screen, and method of manufacturing the screen

(76) Inventor: Naofumi Yamauchi, Chiba-shi (JP)

Correspondence Address: BRUCE L. ADAMS, ESQ., SUITE 1231, 17 BATTERY PLACE, NEW YORK, NY, 10004, US

(21) Appl. No.: 11/258,813

(22) Filed: Oct. 26, 2005

(30) Foreign Application Priority Data
Nov. 5, 2004 (JP) 2004-322402

(51) Int. Cl. G03B 21/60

(52) U.S. Cl. 359/454

(57) ABSTRACT

A large-area projector screen, whose joining gaps are inconspicuous, and a method of producing the screen are provided. The screen according to the present invention is produced by arranging and bonding a surface diffusion sheet having a predetermined haze value and approximately isotropically diffuses incoming light and multiple directional diffusion sheets together. Here, the directional diffusion sheets have a large scattering effect with respect to light incident at a predetermined angle and have a small scattering effect with respect to light incident from other directions. As a result, even when a large screen is formed using a directional scattering sheet divided into multiple regions, boundaries between the divided regions become difficult to visually recognize due to a diffusion action of the surface diffusion sheet and more natural image projection becomes possible.

### BACKGROUND OF THE INVENTION

1. Field of the Invention

The present invention relates to a screen onto which an optical image from a high brightness CRT, a liquid crystal projector, or the like is projected, an image projection system having the screen, and a method of manufacturing the screen.

2. Description of the Related Art

Image projection systems, such as projector devices, which display images by projecting optical images using high brightness CRTs, liquid crystal projectors, or the like can simply and easily display high definition images on large screens, and therefore are being used as information communication tools among multiple users in various ways. As disclosed in JP 11-52107 A, for instance, the light utilization efficiency of a conventional screen used in such an image projection system is improved using a structure, in which a white color material or a reflective film is coated onto a surface of the screen, and the visibility of the screen with respect to multiple viewers is increased by causing light diffusion through distribution of beads across the surface of the screen. Alternatively, as described in JP 2002-169224 A, it becomes possible for multiple observers to observe an image display by providing a directionally reflective structure, such as a lenticular lens, for a screen surface.

Also, there is a large screen whose image area is increased by arranging multiple screens in a plane.

The large screen realized by joining multiple regions together, however, has a problem that seams between the regions are conspicuous and therefore the naturalness of a projected image is impaired, and it is impossible to perform high-quality image projection. Also, it is difficult to join the multiple regions together to produce the large screen.

### SUMMARY OF THE INVENTION

It is therefore an object of the present invention to provide a screen for a projector with which even when an image area is increased by dividing a screen configuration element into multiple regions, it becomes possible to project a natural image, in which seams are inconspicuous, while maintaining directionality, wide viewing angle characteristics, and high image brightness. It is also an object of the present invention to provide a manufacturing method with which it becomes possible to manufacture the projector screen at low cost with high accuracy.

The screen according to the present invention is constructed by joining a surface diffusion sheet, which approximately isotropically diffuses incoming light at its surface, and a directional diffusion sheet, which has a large scattering effect with respect to light incident at a predetermined angle and has a small scattering effect with respect to light incident from other directions, together in this order from an observer's view point side. The surface diffusion sheet has a not-divided and single-sheet configuration and the directional diffusion sheet has a structure in which it is divided into multiple regions. With the structure, even when a large screen is formed using a directional scattering sheet divided into multiple regions, boundaries between the divided regions become difficult to visually recognize due to a diffusion action of the surface diffusion sheet, and more natural image projection becomes possible. In addition, it becomes easy to arrange a directional diffusion sheet adjusted in diffusion characteristics and divided into multiple regions on a screen as appropriate, and it becomes possible to improve the viewing angle characteristics and brightness distribution of a projected image.

### BRIEF DESCRIPTION OF THE DRAWINGS

In the accompanying drawings:

FIG. 1 is a perspective view schematically showing the screen according to the present invention;

FIG. 2 is a flowchart showing steps of the screen manufacturing method according to the present invention;

FIG. 3 is a schematic diagram of an application device that is used in a joining agent application step of the screen manufacturing method according to the present invention;

FIG. 4 is a schematic diagram of a cutting device used in a cutting step of the screen manufacturing method according to the present invention;

FIG. 5 is a schematic diagram of a joining device used in a joining step of the screen manufacturing method according to the present invention;

FIG. 6 is an enlarged cross-sectional view showing a configuration of the screen according to the present invention;

FIG. 7 is another enlarged cross-sectional view showing the configuration of the screen according to the present invention;

FIGS. 8A and 8B are each a plan view schematically showing an arrangement of lenses of the screen according to the present invention;

FIG. 9 is a graph showing characteristics of a directional diffusion sheet used in the present invention; and

FIG. 10 is a graph showing a relation between the haze value of a diffusion surface sheet and a joining gap of the directional diffusion sheet.

### DETAILED DESCRIPTION OF THE PREFERRED EMBODIMENTS

The screen according to the present invention is a screen that displays a projected optical image and includes: a surface diffusion sheet that approximately isotropically diffuses incoming light; and a directional diffusion layer that has a large scattering effect with respect to light incident at a predetermined angle and has a small scattering effect with respect to light incident from other directions, where the directional diffusion layer is divided into multiple regions and the surface diffusion sheet is constructed to extend over the multiple regions of the directional diffusion layer. Alternatively, the surface diffusion sheet may be constructed to cover the multiple regions of the directional diffusion layer. With the configuration, boundaries between the divided regions of the directional diffusion layer become difficult to visually recognize due to a diffusion action of the surface diffusion sheet, so more natural image projection becomes possible. In addition, it becomes possible to give suited diffusion characteristics to each of the multiple regions of the directional diffusion layer, so it becomes possible to improve the viewing angle characteristics and brightness distribution of a projected image with ease.

Also, each of the divided multiple regions of the directional diffusion layer is joined to the surface diffusion sheet. Further, a light reflecting layer is provided on a side opposite to a projection direction of the optical image. Still further, the directional diffusion layer is provided between the surface diffusion sheet and the light reflecting layer and is joined to the light reflecting layer through a joining agent. Alternatively, the directional diffusion layer is provided between the diffusion surface sheet and the light reflecting layer and is joined to the diffusion sheet through a joining agent. Here, the thickness of the above-mentioned joining agent is in a range from 5 μm to 30 μm. With the configuration, it becomes possible to construct a screen with no joining wrinkles and having sufficient joining strength.

Also, the multiple regions of the directional diffusion layer are arranged so that each gap between adjacent regions of the directional diffusion layer becomes 300 μm or less. With the configuration, a screen is obtained in which boundaries between the divided regions are inconspicuous. Also, the haze value of the surface diffusion sheet is in a range from 10% to 70%. As a result, it becomes possible to make the boundaries between the divided regions inconspicuous, reduce a hot spot due to specular reflection from a projector, and project a natural large-screen image.

As a method of manufacturing the surface diffusion sheet described above, it is possible to cite the following method. The surface diffusion sheet is formed by applying an ultraviolet curing resin mixed with diffusion particles to a transparent sheet and fixing the diffusion particles to the transparent sheet by irradiating ultraviolet light while performing heating. With the method, it becomes possible to adjust the haze value of the diffusion surface sheet with ease, so projection of a more natural large-screen image becomes possible.

Also, the image projection system according to the present invention includes a screen having any of the configurations described above and an optical image projector that projects an optical image onto the screen.

Also, the screen manufacturing method according to the present invention includes: a step for applying a joining agent to one surface of a surface diffusion sheet that approximately isotropically diffuses incoming light at its surface; a step for fixing the surface diffusion sheet to a first stage so that the surface applied with the joining agent faces up, arranging and fixing multiple directional diffusion sheets that have a large scattering effect with respect to light incident at a predetermined angle and have a small scattering effect with respect to light incident from other directions to a second stage, and aligning and joining the surface of the surface diffusion sheet applied with the joining agent and the multiple directional diffusion sheets together; and a heat treatment step for heating the surface diffusion sheet and the multiple directional diffusion sheets which are joined together in a pressurized atmosphere.

Alternatively, the screen manufacturing method according to the present invention includes: a joining agent first application step for applying a joining agent to one surface of a surface diffusion sheet that approximately isotropically diffuses incoming light; a joining agent second application step for applying a joining agent to a light reflecting surface of a light reflecting sheet; a joining first step for fixing the surface diffusion sheet to a first stage so that the surface applied with the joining agent faces up, arranging and fixing multiple directional diffusion sheets that have a large scattering effect with respect to light incident at a predetermined angle and have a small scattering effect with respect to light incident from other directions to a second stage, and aligning and joining the surface of the surface diffusion sheet applied with the joining agent and the multiple directional diffusion sheets together; a joining second step for fixing the light reflecting sheet to the first stage so that the surface applied with the joining agent faces up, arranging and fixing the surface diffusion sheet and the multiple directional diffusion sheets joined together to the second stage so that the multiple directional diffusion sheets face up, and aligning and joining the surface of the light reflecting sheet applied with the joining agent and the multiple directional diffusion sheets together; and a heat treatment step for heating the surface diffusion sheet, the multiple directional diffusion sheets, and the light reflecting sheet which are joined together in a pressurized atmosphere.

With the manufacturing methods, it becomes possible to achieve uniform joining strength and, at the same time, reduce each gap between adjacent divided regions to 200 μm or less.

### Embodiment

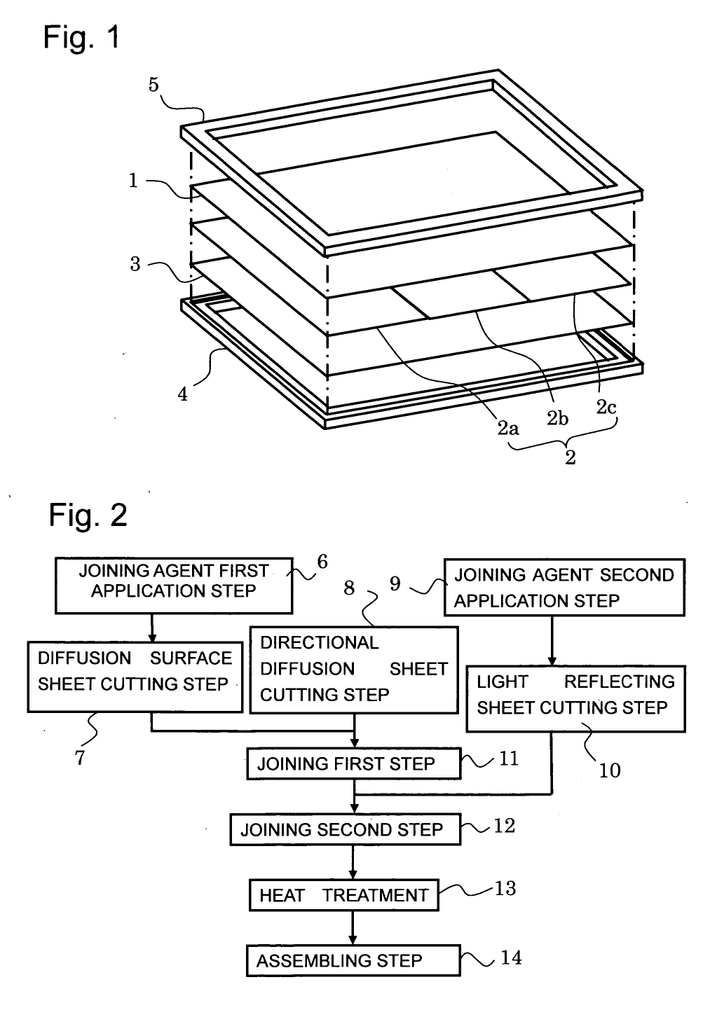

Hereinafter, a screen in this embodiment will be described with reference to the accompanying drawings. FIG. 1 is a schematic perspective arrangement view of the screen in this embodiment. Referring to FIG. 1, in an image projection portion of the screen, a surface diffusion sheet 1, a directional diffusion sheet 2, and a light reflecting sheet 3 are laminated and joined together in order. In this embodiment, the directional diffusion sheet 2 includes three divided regions 2a, 2b, and 2c. The number of the divided regions is determined by the size of the screen and the characteristics of the directional diffusion sheet to be described later, and therefore it is not necessarily required to include three regions.

Also, the screen has a configuration in which the surface diffusion sheet 1, the directional diffusion sheet 2, and the light reflecting sheet 3 are arranged in this order from an observer's view point side. A projector that is applicable to the screen is not limited to a projector, which uses a CRT, a liquid crystal, or a micromirror device as a light modulation element, and includes an ordinary projector, which performs image projection by means of a film, and the like.

In this embodiment, the surface diffusion sheet 1, the directional diffusion sheet 2, and the light reflecting sheet 3 are joined together and are sandwiched between a bearing frame 4 and a pressing frame 5. In this configuration, the bearing frame 4 and the pressing frame 5 each function as a screen support base member. Alternatively, the surface diffusion sheet 1, the directional diffusion sheet 2, and the light reflecting sheet 3 may be joined onto a support substrate having sufficient mechanical strength. In this case, the support substrate functions as the screen support base member. The support substrate may be sandwiched between the bearing frame and the pressing frame described above. Also, diffusion particles may be dispersed in the directional diffusion sheet 2.

FIGS. 8A and 8B each show a concrete configuration of the directional diffusion sheet 2. The directional diffusion sheet 2 is a stripe lens having a structure, in which first regions formed continuously in a thickness direction and having a low refractive index and second regions formed continuously in the thickness direction and having a refractive index that is higher than that of the first regions are formed alternately, and has a function of guiding light in the thickness direction. FIG. 8A is a top view schematically showing the stripe lens. In this drawing, an example is illustrated in which the first regions and the second regions are arranged so that their lengthwise directions extend parallel to the short sides of the sheet. As described above, the stripe lens has a structure in which the high refractive index layers 33 are sandwiched between the low refractive index layers 34. Alternatively, the directional diffusion sheet 2 is a columnar lens having a structure in which multiple columnar structures, in which regions having a refractive index that is higher than that of their peripheral regions are formed continuously in the thickness direction, are provided in a plane. The columnar lens has a function of guiding light in the thickness direction. FIG. 8B is a top view schematically showing the columnar lenses. In this drawing, a structure is illustrated in which the columnar lenses are arranged in a plane and high refractive index regions 33 are surrounded by low refractive index regions 34. The stripe lens and the columnar lens are not necessarily required to be arranged in a regular manner and may be arranged in an irregular manner. When the directional diffusion sheet 2 is constructed using the stripe lens, however, it is preferable that the lamination direction of the first regions and the second regions is set parallel or vertical to the screen.

In the screen according to the present invention, the stripe lens or the columnar lens is arranged so that its optical axis direction (hereinafter referred to as the “orientation direction”) approximately coincides with the optical axis direction of an optical image projected from the projector. That is, the stripe lens or the columnar lens is arranged to be inclined downward on a view point side in the plane of the directional diffusion sheet. Here, needless to say, the directional diffusion sheet may be formed by orientation-forming a thin lens layer or a columnar lens layer having a film thickness on the order of 1 μm to 20 μm on a transparent support base member. Although not illustrated in FIG. 1, a support substrate may be arranged or joined outside the light reflecting sheet 3. By arranging the support substrate outside the light reflecting sheet 3 in this manner, it becomes possible to protect the light reflecting sheet 3 from external mechanical forces, humidity, and the like and prevent degradation of a light reflectance from occurring.

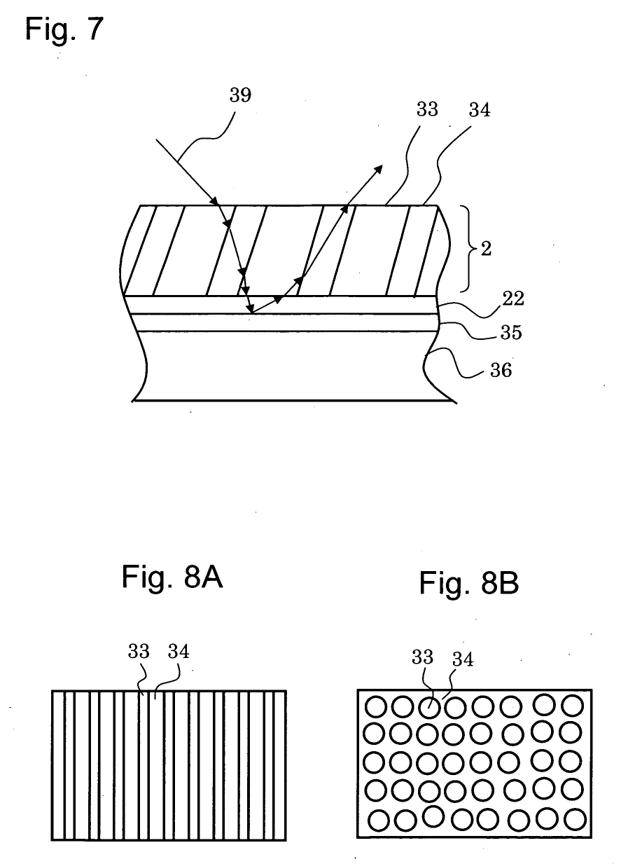

An enlarged structure of the screen according to the present invention and a state of incoming light are schematically shown in FIGS. 6 and 7. The stripe lens or columnar lens constituting the directional diffusion sheet includes the high refractive index regions 33 and the low refractive index regions 34 which is peripheral regions thereof, as described above. Clear boundaries between the high refractive index regions 33 and the low refractive index regions 34 are illustrated in the drawings for ease of description, although such clear boundaries do not exist between the high refractive index regions 33 and the low refractive index region 34 in the case of a graded index columnar lens. It should be noted that in the case of the stripe lens, such differences in refractive index do not exist in a direction vertical to the paper planes of FIGS. 6 and 7. It is possible to manufacture the stripe lens or the columnar lens so that its center axis, that is, its optical axis has an arbitrary inclination on the order of 0 to 70 degrees with respect to a perpendicular line on the film plane.

It is possible to manufacture the directional diffusion sheet by, for instance, irradiating ultraviolet light to a liquid reactive layer made of two or more kinds of photopolymerization compounds, into which diffusion particles have been mixed and which have different refractive indexes, through a photomask that has undergone gradation processing. Here, it is possible to control a refractive index distribution state by changing the intensity of the irradiated light and adjusting differences in photopolymerization speed among the photopolymerization compounds.

When diffusion particles are mixed into the directional diffusion sheet, such diffusion particles are used as particle diameter is sufficiently small as compared with the width of the stripe lens or the diameter of the columnar lens. With other diffusion particles, the lens function of the stripe lens or the columnar lens is lost and, in addition, it becomes impossible to effectively cause a photopolymerization reaction. Typically, it is preferable that the particle diameter of the diffusion particles is set at ⅕ or less of the width of the lens layers or the diameter of the columnar lens.

Also, it is possible to control the inclination of the optical axis of the stripe lens or the columnar lens by adjusting the angle of the irradiated ultraviolet light. When doing so, it is possible to obtain the directional diffusion layer by directly applying the photopolymerization compounds onto the support base member through spin coating, dipping, or the like, and curing the applied compounds, and it is possible to obtain the directional diffusion sheet by applying the photopolymerization compounds onto a reaction stage or a reaction roll, curing the applied compounds, and peeling the cured compounds.

In FIG. 6, examples of the optical path of light incident on the directional diffusion sheet from the outside are illustrated as incoming light 37 and incoming light 38. Light projected onto the screen is incident on the columnar lens with various incoming angels distributed in the angle of divergence of a projected optical image. In the case of a step index directional diffusion sheet, like the incoming light optical paths shown in FIG. 6, light incident on the high refractive index regions 33 is further refracted toward a normal line side of the directional diffusion sheet incident plane according to Snell's law. The incoming light to the high refractive index regions 33 is incident on the boundary surfaces aligned with the low refractive index regions 34, and when the incoming angle to the boundary surfaces is larger than a critical angle, the incident light is totally reflected. The incoming light is thus repeatedly reflected by the boundary surfaces between the high refractive index regions 33 and the low refractive index regions 34, is guided downward, is reflected by the light reflecting layer 35, is guided upward, and exits from the incident plane of the directional diffusion sheet. Here, the directional diffusion sheet 2 and the light reflecting sheet 3 are joined together through a joining layer 22. As the joining layer 22, it is possible to use an ordinary epoxy-based or acryl-based transparent joining agent or transparent adhesive agent.

The light reflecting sheet 3 is obtained by forming a light reflecting layer 35 on a sheet base member 36 through vapor deposition of a metallic material, such as an alloy of Al and Ag or an alloy of Ag and Pd, which has a high reflectance onto the sheet base member 36. As the light reflecting layer 35, films of a dielectric multilayer mirror may be used in which a low refractive index material, such as silicon dioxide or magnesium fluoride, and films of a low refractive index material, such as titanium oxide or zirconium oxide, are alternately laminated with predetermined film thicknesses.

Here, the outgoing position and outgoing direction of the light that exists from the directional diffusion sheet are determined by the sheet thickness of the directional diffusion sheet and the incoming angle and incoming position of the light incident on the high refractive index regions 33. The optical path 37 and the optical path 38 in FIG. 6 have different outgoing angles at which the light is guided through an inner portion of the directional diffusion sheet and then exits from the surface of the directional diffusion sheet again. This occurs because the incoming angles of the optical path 37 and the optical path 38 are the same but the incoming positions thereof are different from each other. A projected image from the projector is incident at various incoming angles and at various incoming positions. Accordingly, the projected image is subjected to an action similar to scattering on a front surface at a certain scattering angle. The scattering angle is determined by a refractive index difference or a refractive index gradient between the high refractive index regions 33 and the low refractive index regions 34, the thickness of the sheet, and the lens diameter of the columnar lens. In other words, the scattering angle of outgoing light becomes larger as the refractive index difference or the refractive index gradient of the directional diffusion sheet becomes greater. Also, the haze value becomes larger as the sheet thickness of the directional diffusion sheet becomes thicker, the lens radius becomes smaller, and the number and density of the columnar lenses within the sheet plane becomes greater. Further, when the incoming angle of light exceeds a specific angle, the incoming light propagates rectilinearly and is transmitted without being scattered. An incoming angle range, in which the incoming light is scattered, will be hereinafter referred to as the “scattering incoming angle”, and an incoming angle range, in which the incoming light propagates rectilinearly and is transmitted, will be hereinafter referred to as the “linear transmission angle”. When the light reflecting layer 35 is not provided, light incident at the scattering incoming angle will be scattered at the time of transmission through the sheet and will exit. This case corresponds to a case where the light reflecting sheet 3 is omitted in FIG. 1 and corresponds to a case of a rear screen in which the projector is arranged behind the screen and projected and transmitted light is observed.

In the screen according to the present invention, it is possible to use a directional diffusion sheet that has columnar lenses with a lens diameter of 1 μm to 500 μm and a lens height (directional diffusion sheet thickness) of 1 μm to 2 mm. When consideration is given to manufacturing yield, optical utilization efficiency, ease of handling, and the like, however, it is preferable that the lens diameter is set at 5 μm to 100 μm and the lens height at the time of use as a sheet is set at 20 μm to 200 μm. Also, it is possible to use columnar lenses having a refractive index difference of 0.01 to 0.05. Further, it is possible to set an inclination angle with respect to a perpendicular line on the columnar lens sheet plane at an arbitrarily angle on the order of 0 to 70 degrees. When the directional diffusion layer is formed on a support substrate and is used, it is possible to reduce the layer thickness of the directional diffusion layer to around 1 μm to 20 μm.

Next, a case where light is incident on the directional diffusion sheet at the linear transmission angle will be described with reference to FIG. 7. The configuration in this drawing is the same as that in FIG. 6 and therefore the description thereof will be omitted. Incoming light 39 is incident on the incident plane of the directional diffusion sheet at a large incoming angle that is equal to or greater than the scattering incoming angle. In this case, the incoming light to the high refractive index regions 33 is refracted into the sheet, penetrates inward, and reaches the boundary of the low refractive index region 34. In this case, however, the incoming angle to the boundary is small, so the light is not totally reflected and penetrates into the low refractive index region 34. The light that penetrates into the low refractive index region 34 enters into the high refractive index region 33 again, is reflected by the light reflecting layer 35 formed on the support substrate 36, and exits from the incident plane of the directional diffusion sheet to the outside. In doing so, when the incoming angle of the light reflected by the light reflecting layer 35 is in the range of the scattering incoming angle, the light that exits from the incident plane is scattered. Also, when the incoming angle of the light reflected by the light reflecting layer 35 is in the range of the linear transmission angle, the light that exits from the incident plane is reflected specularly without being scattered. Further, when the light reflecting layer 35 is not present, the incoming light 39 is transmitted substantially linearly.

On the other hand, the surface diffusion sheet, whose description is omitted, in both of the cases shown in FIGS. 6 and 7 diffuses incoming light or outgoing light. Therefore, the surface diffusion sheet lowers visibility of seams of the directional diffusion sheet divided into multiple regions by widening the viewing angle through an increase of the diffusion angle of projected light from the projector and also diffusing light from the seams. As the haze value of the surface diffusion sheet is increased, the lowering of visibility is increased and the seams become more difficult to see. In this case, however, the directionality possessed by the directional diffusion sheet 2 is also lowered, which lowers the screen front brightness. When the haze value of the surface diffusion sheet is set at around 10% or more, the effect of lowering the visibility of the seams is obtained, but when the haze value exceeds around 70%, the directionality of the directional diffusion sheet is significantly lowered. Therefore, it is preferable that the haze value of the surface diffusion sheet is set at around 10% to 70%.

In addition, the surface diffusion sheet also has an effect of suppressing a hot spot that is a phenomenon in which light from the projector is reflected specularly and directly enters an observer's view point and an observer is dazzled. Although it also depends on the surface light reflectance of the surface diffusion sheet, when the haze value of the surface diffusion sheet is set at around 30% to 55%, the surface diffusion sheet contributes to the action of eliminating the hot spot.

From the above, it is sufficient that the haze value of the surface diffusion sheet is set at around 10% to 70% and it is preferable that the haze value is set at 30% to 55%.

As described above, the directional diffusion sheet used in the present invention possesses superior directionality, so it becomes possible to obtain a very bright and sharp image in a viewing field direction in which light is scattered and reflected. On the other hand, in a directional diffusion sheet direction in which light is not scattered and reflected, the brightness of a projected image is lowered sharply and the visibility is impaired. The surface diffusion sheet and the diffusion particles have an action of widening a viewing field angle by compensating for such a narrow viewing field angle characteristic ascribable to the high directionality of the directional diffusion sheet.

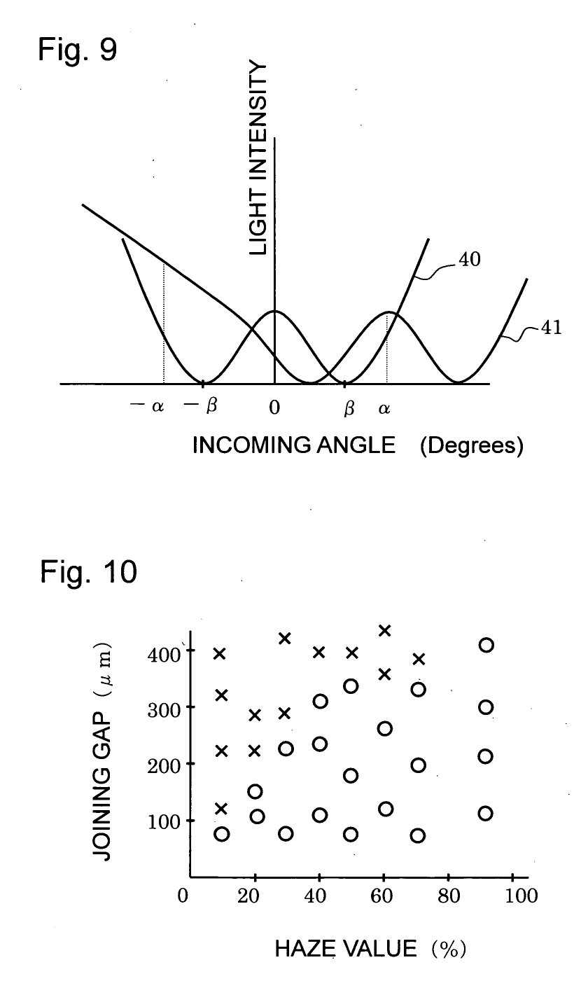

FIG. 9 shows light transmission characteristics of the directional diffusion sheet used in the present invention. The characteristics correspond to a case where the screen according to the present invention is used as a rear screen. It should be noted that no diffusion particles are mixed into the directional diffusion sheet. In FIG. 9, the horizontal axis represents the incoming angle of light to the directional diffusion sheet, while the vertical axis represents the intensity of light transmitted at each incoming angle. A characteristic curve 40 in FIG. 9 indicates the characteristics of the directional diffusion sheet in the case where the orientation direction is at 0 degrees and a characteristic curve 41 indicates the characteristics of the directional diffusion sheet in the case where the orientation direction is at α degrees. It should be noted that measurements were taken in the atmosphere.

The characteristic curve 40 shows that the light intensity becomes substantially zero for the directional diffusion sheet at angles of ±β. When the incoming angle is in a range from −β to β, light is scattered and transmitted, and when the absolute value of the incoming angle is equal to or greater than β, light is transmitted linearly without being scattered. In other words, in the case of transmission, the incoming angle in the range from −β to β is the scattering incoming angle and the incoming angle outside the range is the linear transmission angle. In this specification, for ease of explanation, the angle β is referred to as the “scattering incoming angle”. It should be noted that when diffusion particles are mixed into the directional diffusion sheet, the transmittance does not become zero even at the incoming angle β due to light diffused by the diffusion particles.

On the other hand, the characteristic curve 41 shows that when the orientation direction of the columnar lens is inclined by α degrees, the range of the scattering incoming angle is shifted by the α degrees as it is compared with the cases where the orientation direction is zero degrees. In this case, the angular width of the scattering incoming angle does not substantially change and the range of the scattering incoming angle shifts in a range from (α−β) to (α+β). Therefore, in FIG. 9, light incident at the angle α is scattered at the time of transmission, while light incident at the angle −α is transmitted linearly without being scattered. Consequently, it becomes possible to obtain a bright image having a wide viewing field angle by irradiating the optical image from the projector with an incline of its optical axis by α with respect to the screen and also by setting the angle of divergence of the projected image to ±β.

Next, the characteristics of the directional diffusion sheet applied to the projector screen according to the present invention used as a reflection-type screen (front screen) will be described using FIG. 9.

First, the case of the characteristic curve 40 where the orientation direction is set at 0 degrees will be considered. In this case, light projected from the projector and incident at an angle of β to −β is reflected and scattered by the light reflecting layer of the projector screen. When y is set as an angle larger than β, however, light incident at the incoming angle γ is reflected specularly and is not scattered. Accordingly, external incoming light having an incoming angle equal to or more than β does not exert any influence on a projected image, so it becomes possible to obtain a projected image having favorable image quality.

Next, the case of the characteristic curve 41 where the orientation direction of the directional diffusion sheet is inclined by α will be considered. An optical image projected from the projector with an incoming angle in a range from (α−β) to (α+β) is scattered and reflected. Also, light projected from the projector with an incoming angle in a range from (−α−β) to (−α+β) is reflected by the light reflecting layer, follows an optical path similar to that of light having an incoming angle in the range from (α−β) to (α+β), is scattered by the surface, and exits. In other words, there exist the above-mentioned two angular ranges in which light is scattered by the screen. On the other hand, light incident at an angle outside the two scattering incoming angle ranges is scattered by the optical scattering layer but is linearly reflected by the directional diffusion sheet. Therefore, external light incident at an angle outside the two scattering incoming angle ranges exerts little influence on a projected image, so it becomes possible to obtain a projected image having favorable image quality.

It is possible to control β to assume an arbitrary value on the order of 10 to 45 by adjusting the sheet thickness of the columnar directional diffusion sheet, the diameter of the columnar lens, the refractive index difference of the columnar lens, and the like.

Now, referring again to FIG. 1, the orientation direction of the layered lens or columnar lens constituting the directional diffusion sheets 2a, 2b, and 2c divided into multiple regions is changed and set so that observation of a projected image at a wider angle is possible. In particular, by inclining the orientation direction of the directional diffusion sheets of the screen arranged vertically or horizontally in a screen front direction, it becomes possible to project an image that is uniform and has naturalness.

It should be noted that FIG. 1 shows only the fundamental configuration of the present invention. In other words, black stripes having the same pitch as the pixel pitch of a projected image may be arranged on a surface of the directional diffusion sheet. With the configuration, it becomes possible to project a sharper image. It is possible to easily form the black stripes by printing a binder into which a black dye like a light absorbing coloring matter, a black pigment like carbon, or the like is mixed. The black stripes may be formed on any surface of the directional diffusion sheet, but it is preferable to form the black stripes on a surface on a side opposite to a view point in the case of the front screen shown in FIG. 1 and on a surface on the same side as the view point in the case of the rear screen in which the light reflecting sheet is omitted from the configuration shown in FIG. 1.

Also, as the black stripes, it is possible to use a so-called louver obtained by forming a layered stripe pattern, into which a light absorbing pigment or coloring agent has been mixed, in a vertical direction to a surface of a transparent acrylic plate. As the light absorbing pigment, carbon powder is used in ordinary cases. The louver functions as a black stripe sheet in which black regions and transparent regions are alternately laminated in a layer manner in an in-plane direction. It should be noted that even when the pitch of the black stripes is several times to several tens of times as large as the pixel pitch, the visibility is improved as compared with a case where the black stripes are not provided.

Also, it is possible to increase the contrast of the projected image by affixing a polarizing sheet to a surface on a view point side of the surface diffusion sheet 1, when image modulation elements of the projector 5 are polarizing elements such as liquid crystal elements. In the case of such a polarizing projector, the optical image is projected as light that is polarized with respect to a specific direction. Therefore, when the polarization axis of the polarizing sheet is aligned with the polarization direction of the projected optical image, the optical loss of the projected image from the polarizing projector is suppressed, but the half of external light that is incident on the screen from the view point 9 side is absorbed by the polarizing sheet, so the contrast is increased. It should be noted that when a color image is projected with the polarizing projector, this effect becomes remarkable only when the polarization directions of RGB images are the same.

Hereinafter, the method of manufacturing the screen according to the present invention will be described with reference to the drawings. A method of manufacturing a screen having the configuration shown in FIG. 1 will be described based on FIG. 2. That is, FIG. 2 is a flowchart of the screen manufacturing method. The manufacturing method includes: a joining agent first application step 6 for applying a joining agent to one surface of the surface diffusion sheet 1; a surface diffusion sheet cutting step 7 for cutting the surface diffusion sheet 1 into a predetermined size; a joining agent second application step 9 for applying a joining agent to a light reflecting surface of the light reflecting sheet 3; a light reflecting sheet cutting step 10 for cutting the light reflecting sheet 3 into a predetermined size; a directional diffusion sheet cutting step 8 for cutting the directional diffusion sheet 2 into a predetermined size; a joining first step 11 for fixing the surface diffusion sheet 1 to a first stage so that the surface applied with the joining agent faces up, arranging and fixing the directional diffusion sheet 2 to a second stage, and aligning and joining the surface of the surface diffusion sheet 1 applied with the joining agent and the directional diffusion sheet 2 together by rotating/parallel-moving the first stage and the second stage; a joining second step 12 for fixing the light reflecting sheet 3 to the first stage so that the surface applied with the joining agent faces up, arranging and fixing the surface diffusion sheet 1 and the directional diffusion sheet 2 joined together to the second stage so that the directional diffusion sheet 2 faces up, and aligning and joining the surface of the light reflecting sheet 3 applied with the joining agent and the directional diffusion sheet 2 together by rotating/parallel-moving the first stage and the second stage; a heat treatment step 13 for heating the surface diffusion sheet 1, the directional diffusion sheet 2, and the light reflecting sheet 3 joined together in a pressurized atmosphere; and an assembling step 14 for attaching the heat-treated surface diffusion sheet, the directional diffusion sheet, and the light reflecting sheet to a support base member.

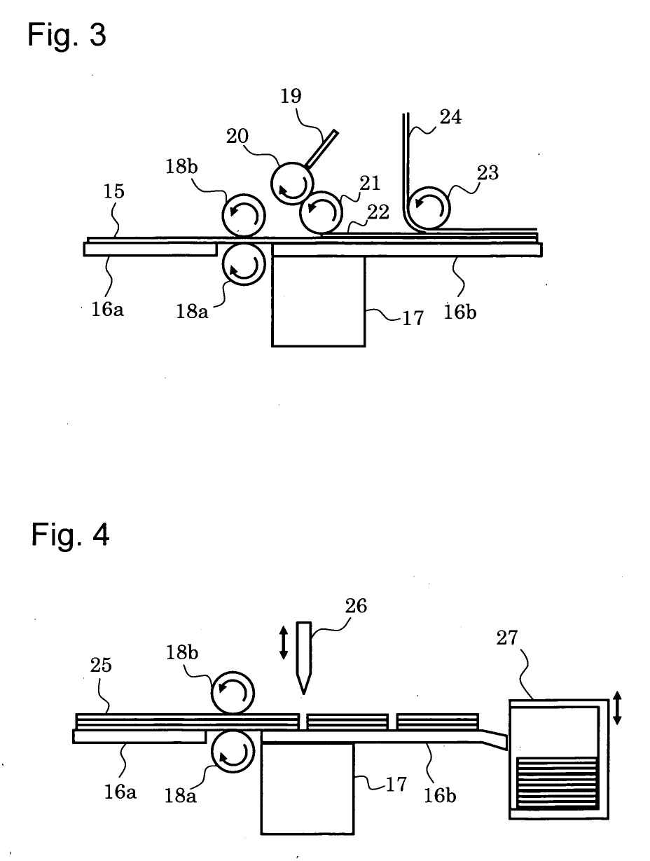

First, the surface diffusion sheet joining agent application step 6 and the light reflecting sheet joining agent application step 9 will be described with reference to FIG. 3. FIG. 3 shows an example of a device used in the surface diffusion sheet joining agent application step 6 and the light reflecting sheet joining agent application step 9. The device moves a sheet 15 on conveyor stages 16a and 16b disposed on a base 17 and applies a joining agent to a surface of the sheet 15. The sheet 15 is the surface diffusion sheet 1 and the light reflecting sheet 3. Here, in many cases, the sheet 15 is supplied from a not-shown raw material roll wound in a roll manner. The sheet from the raw material roll is moved at a set constant speed on the conveyor stages 16a and 16b through rotation of feed rollers 18a and 18b in arrow directions.

Also, behind the feed rollers 18a and 18b, an application first roller 20 and an application second roller 21 for applying the joining agent are arranged. The application first roller 20 and the application second roller 21 are rotated in arrow directions and the tangential velocities of the feed rollers 18a and 18b and the tangential velocity of the application second roller 21 are brought into a strict coincidence. A joining agent supply nozzle 19 supplies a constant supply amount of the joining agent onto the application first roller 20. The joining agent supply nozzle 19 has a slit-shaped supply hole, which is somewhat wider than an application width, and supplies and applies the joining agent to a surface of the joining agent application first roller 20 with an approximately uniform layer thickness. It is possible to obtain an appropriate supply amount of the joining agent by adjusting the extrusion pressure of the joining agent and the slit width. Then, the joining agent 22 is transferred and applied onto the sheet 15 from the application second roller 21 provided to be spaced apart from the sheet 15 at a predetermined distance.

In addition, a space between the application first roller 20 and the application second roller 21 is adjusted so that the rollers 20 and 21 rotate with the joining agent in-between and the joining agent is transferred from the application first roller 20 onto the application second roller 21 with a uniform layer thickness. It is possible to adjust the layer thickness of the joining agent transferred to the application second roller 21 by selecting the set gap between the application first roller 20 and the application second roller 21, the surface materials of the rollers, and the viscosity of the joining agent as appropriate. Also, it is possible to adjust the thickness of the joining agent transferred and applied onto the sheet 15 by selecting the set gap between the sheet 15 and the application second roller 21, the surface materials of the rollers, and the viscosity of the joining agent as appropriate. More specifically, a condition for applying the joining agent 22 with a desired thickness is obtained by using rollers made of a roller surface material that is an elastic material such as a rubber-based resin or polyester elastomer, transferring the joining agent onto the sheet 15 while changing the gap between the application first roller 20 and the application second roller 21 and the gap between the sheet 15 and the application second roller 21, measuring the layer thickness, and adjusting the gaps of the rollers so that the layer thickness assumes a predetermined value.

The joining agent 22 is applied in a room having high air cleanliness and is sent to the next step swiftly in order to prevent a situation from occurring in which dust or the like adheres onto a surface and adhesive force is lost or the surface is flawed. Depending on the manufacturing environment or step situation, however, there is a case where there is a danger that dust will adhere onto the joining agent before the next step. In order to solve the problem, a projective sheet joining roller 23 is arranged behind the application rollers and a projective sheet 24 is placed on a surface of the joining agent 22. As the protective sheet 24, a high polymer sheet having weak joining force with the joining agent is used. With this configuration, handling of the sheet 15 after the application of the joining agent 22 also becomes easy.

Conventionally, as the joining agent 22, an adhesive agent is used. When strong joining force is required, however, it is also possible to use a thermosetting bonding agent, an ultraviolet curing bonding agent, or the like. When a bonding agent is used as the joining agent, however, it is impossible to use the protective sheet 24 described above, so it is required to send the sheet 15 to the next step swiftly after the application of the bonding agent.

Also, when the ultraviolet curing bonding agent is used as the bonding agent, an ultraviolet light irradiation step becomes necessary before or during the heat treatment step 13. The ultraviolet light irradiation step is a step for solidifying the ultraviolet curing bonding agent by irradiating ultraviolet light and completing fixation through the joining.

Further, when the thermosetting bonding agent is used, the bonding agent is cured in the heat treatment step 13 and the joining is completed. Needless to say, when the light reflecting sheet is not used in the screen configuration, the joining agent second application step 9 is omitted.

The sheet having undergone the joining agent application step shown in FIG. 3 is wound up in a roll manner again or is sent to the next step as it is, that is, without being wound up. In this manner, the joining agent is applied to the surface diffusion sheet 1 and the projective sheet is placed on the joining agent in the joining agent first application step 6. Also, in the joining agent second application step 9, the joining agent is applied to the light reflecting surface of the light reflecting sheet 3 and the protective sheet is placed on the joining agent.

Next, the surface diffusion sheet cutting step 7, the directional diffusion sheet cutting step 8, and the light reflecting sheet cutting step 10 will be described with reference to FIG. 4. FIG. 4 is a side cross-sectional view schematically showing a configuration of a cutting device used in the sheet cutting steps described above. A sheet 25 cut in FIG. 4 is the surface diffusion sheet on which the adhesive agent 22 and the protective sheet 24 have been applied, the light reflecting sheet on which the adhesive agent 22 and the protective sheet 24 have been applied, and the directional diffusion sheet not having undergone surface processing.

The cutting device shown in FIG. 4 performs processing of a sheet wound in a roll manner after the joining agent application step shown in FIG. 3 or a sheet conveyed on a conveyor stage common to the joining agent application device shown in FIG. 3. The sheet 25 is sent at a predetermined speed by feed rollers 18a and 18b on conveyor stages 16a and 16b on a base 17. A cutting blade 26 is arranged behind the feed rollers 18a and 18b and cuts the sheet 25 by moving in an arrow direction in the drawing. The cutting blade 26 shown in the drawing is a press-cut-type cutting blade, but a shear-type cutting blade having an upper cutting edge and a lower cutting edge is also usable. In addition, an ultrasonic cutter, a laser cutter, and the like are also usable.

The timing of cutting by the cutting blade 26 is adjusted in accordance with the speed of sending of the sheet 25 and it is made possible to cut the sheet 25 with a predetermined width.

The cutting widths of the surface diffusion sheet and the light reflecting sheet are set equal to the vertical width or the horizontal width of the projector screen, and the cutting width of the directional diffusion sheet is set in accordance with the size of the divided regions. The accuracy of joining of adjacent divided regions of the directional diffusion sheet is determined by the accuracy of the cutting. By setting the joining accuracy at around 300 μm or less, joining of the directional diffusion sheet, in which seams are inconspicuous, becomes possible.

The sheet 25 cut in the manner described above is stacked and stored in a stocker 27. As a matter of course, the cut sheet 25 may be sent directly to the next step without being stored in the stocker 27. Here, needless to say, when the light reflecting sheet is not used in the screen configuration, the light reflecting sheet cutting step 10 is omitted.

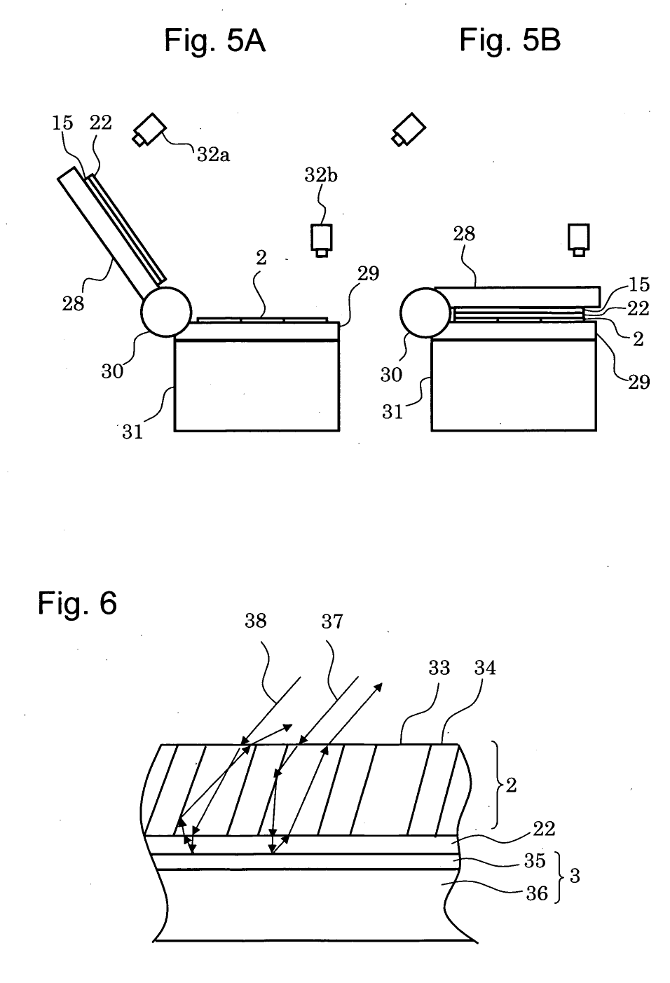

A step for joining together the sheets cut in the manner described above will be described with reference to FIG. 5. FIGS. 5A and 5B are each a cross-sectional view schematically showing a configuration of a joining device used in the projector screen manufacturing according to the present invention, with FIG. 5A being a side view schematically showing a state at the time of setting of the cut sheets in the joining device and FIG. 5B being a side view schematically showing a state at the time of joining of the cut sheets. In FIGS. 5A and 5B, the joining device includes a base 31, a joining drive portion 30, an upper adsorption board 28, a lower adsorption board 29, and CCD cameras 32a and 32b. In surfaces of the upper adsorption board 28 and the lower adsorption board 29 on which the sheets are placed, multiple suction and adsorption holes are established. By placing the sheets on the upper adsorption board 28 and the lower adsorption board 29 and sucking the air through the suction and adsorption holes, the sheets are adsorbed and fixed. It is possible to switch air suction force between two levels that are a strong level and a weak level. It is possible to perform alignment of the sheets under a state, in which the air suction force is set at the weak level and the sheets are semi-fixed, and fix the sheets by setting the air suction force at the strong level after the sheets are positioned.

At the time of setting the cut sheets in the joining device, as shown in FIG. 5A, the upper adsorption board 28 is opened in a hinged-door manner and is separated from the lower adsorption board 29. In FIG. 5A, the diffusion surface sheet or light reflecting sheet 15, on which the joining agent 22 has been applied, is positioned on the upper adsorption board 28 and is adsorbed and fixed by the upper adsorption board 28 and multiple directional diffusion sheets 2 are positioned on the lower adsorption board 29 and are adsorbed and fixed by the lower adsorption board 29. After the adsorption and fixation, the protective sheet on the sheet on the upper adsorption board 28 is peeled off.

Here, alignment of the multiple divided regions of the directional diffusion sheet 2 is performed by abutting the cut end surfaces of the sheet against each other. Accordingly, the accuracy of alignment of adjacent divided regions of the directional diffusion sheet 2 is determined by the accuracy of the sheet cutting in the sheet cutting step described with reference to FIG. 4.

The CCD cameras 32a and 32b are respectively arranged for the upper adsorption board 28 and the lower adsorption board 29 and pick up images at predetermined positions of the upper adsorption board 28 and the lower adsorption board 29 for sheet position measurement. In accordance with a numerical value or image information calculated from images from the CCD cameras, alignment of the sheets adsorbed by the adsorption boards under the semi-fixed state is performed by a not-shown position adjustment mechanism or through a manual operation. As to reference points for the alignment, the vertexes of each sheet may be set as the reference points or alignment marks may be printed on the sheets as the reference points. The coordinates of the reference points of the sheets positioned in the manner described above are read by the respective CCD cameras 32a and 32b and are recorded in a memory in a not-shown control circuit of the joining device.

After the sheets are fixed to the upper adsorption board 28 and the lower adsorption board 29 as in the manner described above, the joining drive portion 30 is actuated. As a result, as shown in FIG. 5B, the upper adsorption board 28 is rotated and parallel-moved, a sheet fixing surface of the upper adsorption board 28 is set to oppose a sheet fixing surface of the lower adsorption board 29, and the sheets are pressed with a predetermined pressure. Joining positions of the upper adsorption board 28 and the lower adsorption board 29 are determined in accordance with the coordinates of the reference points of the sheets recorded in the memory of the control circuit described above and joining is performed through position control by the joining drive portion 30.

In the manner described above, in this step, the sheet 15 and the directional diffusion sheet 2 are joined together through the joining agent 22. When the joining agent is used as an adhesive agent, the joining of the respective sheets is completed at the time when this step is finished. Also, when the joining agent is a thermosetting bonding agent or an ultraviolet curing bonding agent, it is required to send the joined sheets to the next heat treatment step or the ultraviolet light irradiation step with care so that the sheets will not be misaligned.

Here, needless to say, when the light reflecting sheet is not used in the screen configuration, only the joining first step 11 for joining the surface diffusion sheet 1 and the directional diffusion sheet 2 together is carried out, and the joining second step 12 for joining the light reflecting sheet 3 and the directional diffusion sheet 2 together is omitted.

After the surface diffusion sheet 1 and the light reflecting sheet 3 are joined to both surfaces of the directional diffusion sheet 2 in this manner, the next heat treatment step 13 is executed.

When a thermosetting bonding agent is used as the joining agent, the heat treatment step 13 is carried out in order to solidify the bonding agent and complete the joining. An appropriate heating temperature in this step varies depending on the kind of the bonding agent and the material of the sheet, but in this embodiment, heating is performed at 60° C. to 120° C. for 5 to 30 minutes under the atmospheric pressure. The heating may be performed with a batch furnace. Alternatively, the heating may be performed using a belt furnace.

On the other hand, when an adhesive agent is used as the joining agent, the heat treatment step 13 is carried out for the sake of removable of air bubbles contained in the joining agent. More specifically, with a batch furnace that is capable of performing pressurization, heating is performed at 30° C. to 50° C. for around 10 to 30 minutes under a state in which the atmospheric pressure has been increased by two atmospheres. As a result of this treatment, the air bubbles trapped in the adhesive agent are removed and it becomes possible to obtain uniform adhesion across the entire surface of the sheet.

Finally, the surface diffusion sheet 1, the directional diffusion sheet 2, and the light reflecting sheet 3 joined together as in the manner described above are sandwiched and fixed between support frames (the bearing frame 4 and the pressing frame 5) in the assembling step 14, and the screen manufacturing process is ended.

It should be noted that in the sheet cutting steps among the steps described above, the sheets may be cut to have rather large outer peripheral dimensions. In this case, before the assembling step 14, the outer peripheries are cut-finished using a blade having a rectangular shape with the same dimensions as the screen outside shape. By performing such cut-finishing, it becomes possible to correct sheet misalignment in outer peripheral portions, remove outer peripheral regions in which joining failures tend to occur, and improve screen quality.

With the projector screen manufacturing method according to the present invention described above, uniform sheet joining, in which joining gaps between sheets have been reduced to 300 μm or less and joining unevenness has been eliminated, becomes possible, which makes it possible to manufacture a high-quality screen.

Hereinafter, a concrete example of the screen according to the present invention will be described.

### CONCRETE EXAMPLE

A screen shown in FIG. 1 having the surface diffusion sheet, the directional diffusion sheet, and the light reflecting sheet was formed. As the directional diffusion sheet, a sheet having a columnar structure with a sheet thickness of 70 μm and a diameter of 50 μm was used. The orientation angle of the columnar structure was set at zero degrees. Also, as the light reflecting sheet, a sheet obtained by vacuum-depositing Ag onto a surface of a polyethylene sheet to have a thickness of around 200 nm was used.

The directional diffusion sheet was divided into two regions and a joining gap between the regions was changed. That is, two directional diffusion sheets were bonded onto the light reflecting sheet, a joining gap between the two directional diffusion sheets was measured with a scale of a microscope, and then the surface diffusion sheet was bonded to a surface of the directional diffusion sheet. In this example, samples respectively using surface diffusion sheets with haze values of 10%, 20%, 30%, 40%, 50%, 60%, 70%, and 90% were produced. A joining portion of the screen produced as in the manner described above was visually observed from a position spaced apart from the screen by 30 centimeters and it was checked whether the seam can be seen or not. It should be noted that five subjects having ordinary visual acuity were selected and a majority judgment result was adopted as to the possibility of the visual observation. That is, a judgment made by three or more persons among the five subjects was adopted. Results of the visual observation are shown in FIG. 10. Here, the horizontal axis represents the haze values of the surface diffusion sheets on a percentage basis and the vertical axis represents the joining gap measurement values of the directional diffusion sheets in units of μm. Also, each case where the joining gap discrimination was impossible is indicated with a sign “o” and each case where the joining gap observation was possible is indicated with a sign “x”.

It can be understood from FIG. 10 that as the haze value of the surface diffusion sheet is increased, the joining gap becomes more difficult to see. In addition, it can be understood that even when the haze value of the surface diffusion sheet is 70% or less, when the joining gap is set at around 300 μm or less, it becomes possible to prevent the seam from being seen. On the other hand, when the haze value of the surface diffusion sheet exceeds around 70%, the directional effect of the directional diffusion sheet is not effectively exercised, so screen front brightness is lowered. Also, when the haze value of the surface diffusion sheet is around 10% or less, this results in an unpreferable situation in which a hot spot appears because the diffusion effect of the surface light is small and the seam is conspicuous unless the sheet joining accuracy is set at around 100 μm or less. Therefore, it is preferable that the haze value of the surface diffusion sheet is in a range from 10% to 70%.

As described above, according to the present invention, it becomes possible to provide a thin, lightweight, and large-area projector screen having favorable viewing angle characteristics and brightness characteristics. With the screen according to the present invention, it becomes possible to improve the display quality of a projection system and realize miniaturization and weight reduction of the projection system.

Also, with the screen according to the present invention, it becomes possible to obtain a large-screen image with favorable visibility even in a bright room under an illuminated environment, so it becomes possible to realize a bright and favorable presentation environment at a conference or a site for education. Further, it becomes possible to project a large and natural image, so it becomes possible to improve a theater environment in a movie theater, a mini-theater, or the like. In addition, with the screen manufacturing method according to the present invention, it becomes possible to realize a high-quality and large-area screen at low cost.

What is claimed is:

1. A screen that displays a projected optical image, comprising:
a surface diffusion sheet that approximately isotropically diffuses incoming light; and
a directional diffusion layer that has a large scattering effect with respect to light incident at a predetermined angle and has a small scattering effect with respect to light incident from other directions,
wherein the directional diffusion layer is divided into a plurality of regions and the surface diffusion sheet is constructed to extend over the plurality of regions of the directional diffusion layer.

2. A screen according to claim 1,
wherein the surface diffusion sheet is constructed to cover the plurality of regions of the directional diffusion layer.

3. A screen according to claim 1,
wherein each of the plurality of divided regions of the directional diffusion layer is joined to the surface diffusion sheet.

4. A screen according to claim 1, further comprising a light reflecting layer provided on a side opposite to a projection direction of the optical image.

5. A screen according to claim 4,
wherein the directional diffusion layer is provided between the surface diffusion sheet and the light reflecting layer and is joined to the light reflecting layer.

6. A screen according to claim 4,
wherein the directional diffusion layer is provided between the surface diffusion sheet and the light reflecting layer and is joined to the surface diffusion sheet.

7. A screen according to claim 6,
wherein a thickness of the joining agent is in a range from 5 μm to 30 μm.

8. A screen according to claim 1,
wherein the plurality of regions of the directional diffusion layer are arranged so that each gap between adjacent regions of the directional diffusion layer becomes 300 μm or less.

9. A screen according to claim 1,
wherein the haze value of the surface diffusion sheet is in a range from 10% to 70%.

10. A screen according to claim 1,
wherein the surface diffusion sheet is formed by applying an ultraviolet curing resin mixed with diffusion particles to a transparent sheet and fixing the diffusion particles to the transparent sheet by irradiating ultraviolet light while performing heating.

11. An image projection system comprising:
a screen; and
an optical image projector that projects an optical image onto the screen,
wherein the screen includes a surface diffusion sheet that approximately isotropically diffuses incoming light and a directional diffusion layer that has a large scattering effect with respect to light incident at a predetermined angle and has a small scattering effect with respect to light incident from other directions, and
wherein the directional diffusion layer is divided into a plurality of regions and the surface diffusion sheet is provided to extend over the plurality of regions of the directional diffusion layer.

12. A screen manufacturing method comprising the steps of:
applying a joining agent to one surface of a surface diffusion sheet that approximately isotropically diffuses incoming light;
fixing the surface diffusion sheet to a first stage so that the surface applied with the joining agent faces up, arranging and fixing a plurality of directional diffusion sheets that have a large scattering effect with respect to light incident at a predetermined angle and have a small scattering effect with respect to light incident from other directions to a second stage, and aligning and joining the surface of the surface diffusion sheet applied with the joining agent and the plurality of directional diffusion sheets together; and
heating the surface diffusion sheet and the plurality of directional diffusion sheets joined together in a pressurized atmosphere.

13. A screen manufacturing method comprising:
a first applying step of applying a joining agent to one surface of a surface diffusion sheet that approximately isotropically diffuses incoming light;
a second applying step of applying a joining agent to a light reflecting surface of a light reflecting sheet;
a first fixing step of fixing the surface diffusion sheet to a first stage so that the surface applied with the joining agent faces up, arranging and fixing a plurality of directional diffusion sheets that have a large scattering effect with respect to light incident at a predetermined angle and have a small scattering effect with respect to light incident from other directions to a second stage, and aligning and joining the surface of the surface diffusion sheet applied with the joining agent and the plurality of directional diffusion sheets together;
fixing the light reflecting sheet to the first stage so that the surface applied with the joining agent faces up, arranging and a second fixing step of fixing the surface diffusion sheet and the plurality of directional diffusion sheets joined together to the second stage so that the plurality of directional diffusion sheets face up, and aligning and joining the surface of the light reflecting sheet applied with the joining agent and the plurality of directional diffusion sheets together; and
heating the surface diffusion sheet, the plurality of directional diffusion sheets, and the light reflecting sheet joined together in a pressurized atmosphere.

14. A screen according to claim 5,
wherein a thickness of the joining agent is in a range from 5 μm to 30 μm.
